(19) United States
(12) Patent Application Publication
(10) Pub. No.: US 2007/0127480 A1
(43) Pub. Date: Jun. 7, 2007

(54) Method for implementing packets en-queuing and de-queuing in a network switch

(75) Inventors: Wei-Pin Chen, Taipei (TW); Chao-Cheng Cheng, Taipei (TW); Chung-Ping Chang, Taipei (TW); Yu-Ju Lin, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/292,617

(22) Filed: Dec. 2, 2005

(51) Int. Cl. H04L 12/28; H04J 3/16; H04L 12/56; H04J 3/22

(52) U.S. Cl. 370/392; 370/389; 370/469

(57) ABSTRACT

A method for implementing packet en-queuing and de-queuing processes in a network switch is provided. The method comprises the following steps. First, an en-queuing process and a de-queuing process are divided into a plurality of en-queuing and de-queuing stages. The en-queuing process of a plurality of en-queued packets is then processed with each of the plurality of en-queued packets processed in one of the plurality of en-queuing stages simultaneously, and every one of the plurality of en-queued packets passes through all of the plurality of en-queuing stages sequentially to complete the en-queuing process. The de-queuing process of a plurality of de-queued packets is then processed with each of the plurality of de-queued packets processed in one of the plurality of de-queuing stages simultaneously, and every one of the plurality of de-queued packets passes through all of the plurality of de-queuing stages sequentially to complete the de-queuing process.

### BACKGROUND

The present invention relates to a network, and more particularly, to a network switch.

A network switch is a computer networking device that cross connects stations or network segments. A switch can connect Ethernet, Token Ring, or other types of packet switched network segments to form a heterogeneous network operating at OSI Layer 2.

As a frame comes into a switch, the switch saves the originating MAC address and the originating port in the MAC address table of the switch. The switch then selectively transmits the frame from specific ports based on the destination MAC address of the frame and previous entries in the MAC address table. If the MAC address is unknown, or a broadcast or multicast address, the switch simply floods the frame out of all of the connected interfaces except the incoming port. If the destination MAC address is known, the frame is forwarded only to the corresponding port in the MAC address table. If the destination port is the same as the originating port, the frame is filtered out and not forwarded.

Because a switch receives a lot of packets from a plurality of ingress ports, it must decide the processing sequence for the packets before forwarding them to the destination egress port. Thus, many packets must be stored in a queue in the memory of the switch while waiting to be processed. The process of inserting a packet into the waiting queue is called “en-queuing”, and the process of retrieving a packet from the waiting queue for processing is called “de-queuing”. The de-queuing sequence is according to the “first-in, first-out” (FIFO) method.

Because en-queuing and de-queuing are typical switch processes, implementing these processes efficiently can effectively improve the switch performance. For example, implementing the en-queuing and de-queuing processes efficiently can increase the number of packets able to be processed at the same time, thus increasing the switch bandwidth.

### SUMMARY

The invention provides a method for implementing packet en-queuing and de-queuing processes in a network switch. An exemplary embodiment of the method comprises the following steps. First, an en-queuing process and a de-queuing process are divided into a plurality of en-queuing and de-queuing stages. The en-queuing process of a plurality of en-queued packets is then processed with each one of the plurality of en-queued packets processed in one of the plurality of en-queuing stages simultaneously, and every one of the plurality of en-queued packets passes through all of the plurality of en-queuing stages sequentially to finish the en-queuing process. The de-queuing process of a plurality of de-queued packets is then processed with each one of the plurality of de-queued packets processed in one of the plurality of de-queuing stages simultaneously, and every one of the plurality of de-queued packets passes through all of the plurality of de-queuing stages sequentially to finish the de-queuing process.

A network switch is also provided. An exemplary embodiment of the network switch comprises a pipelined en-queuing engine for processing an en-queuing process of a plurality of en-queued packets. The en-queuing process is divided into a plurality of en-queuing stages, each one of the plurality of en-queued packets is processed in one of the plurality of en-queuing stages simultaneously, and every one of the plurality of en-queued packets passes through all of the plurality of en-queuing stages sequentially to finish the en-queuing process. The network switch also comprises a pipelined de-queuing engine for processing a de-queuing process of a plurality of de-queued packets. The de-queuing process is divided into a plurality of de-queuing stages, each one of the plurality of de-queued packets is processed in one of the plurality of de-queuing stages simultaneously, and every one of the plurality of de-queued packets passes through all of the plurality of de-queuing stages sequentially to finish the de-queuing process.

### DESCRIPTION OF THE DRAWINGS

The invention can be more fully understood by reading the subsequent detailed description in conjunction with the examples and references made to the accompanying drawings, wherein:

FIG. 1(a)˜(e) illustrate the packet en-queuing and de-queuing process;

FIG. 2(a) shows an example of the queues for storing packets;

FIG. 2(b) shows an example of linked list table for storing the packets in the queues in FIG. 2(a);

FIG. 3 shows an example of the functional blocks of en-queuing and de-queuing processes of a network switch;

FIG. 4 shows an embodiment of the functional blocks of en-queuing and de-queuing processes of a network switch according to the invention;

FIG. 5 shows an embodiment of an en-queuing process implementing by the pipelined en-queuing engine;

FIG. 6 shows an embodiment of a de-queuing process implementing by the pipelined de-queuing engine.

### DETAILED DESCRIPTION

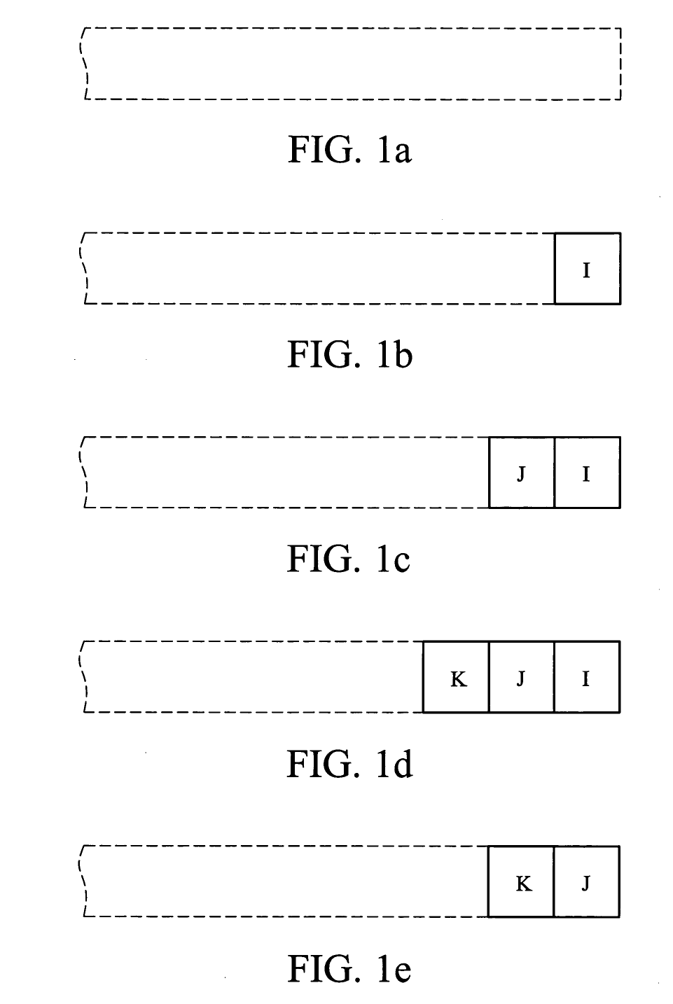

FIG. 1 illustrates the packet en-queuing and de-queuing process. FIG. 1(a) is an empty queue, and both the head pointer and tail pointer of the empty queue point to null. FIG. 1(b) shows the queue after a packet with packet-id I is en-queued to the empty queue, and both the head pointer and tail pointer of this queue point to the packet I. FIG. 1(c) shows the queue after a packet with packet-id J is further en-queued to the queue. At this time the head pointer of the queue still points to the packet I, but the tail pointer of the queue points to the packet J. FIG. 1(d) shows the queue after a packet with packet-id K is further en-queued to the queue. At this time the head pointer of the queue still points to the packet I, but the tail pointer of, the queue points to the packet K. FIG. 1(e) shows the queue after de-queuing. Now the packet I is de-queued for processing, and the head and tail pointers of the queue respectively point to packets J and K respectively.

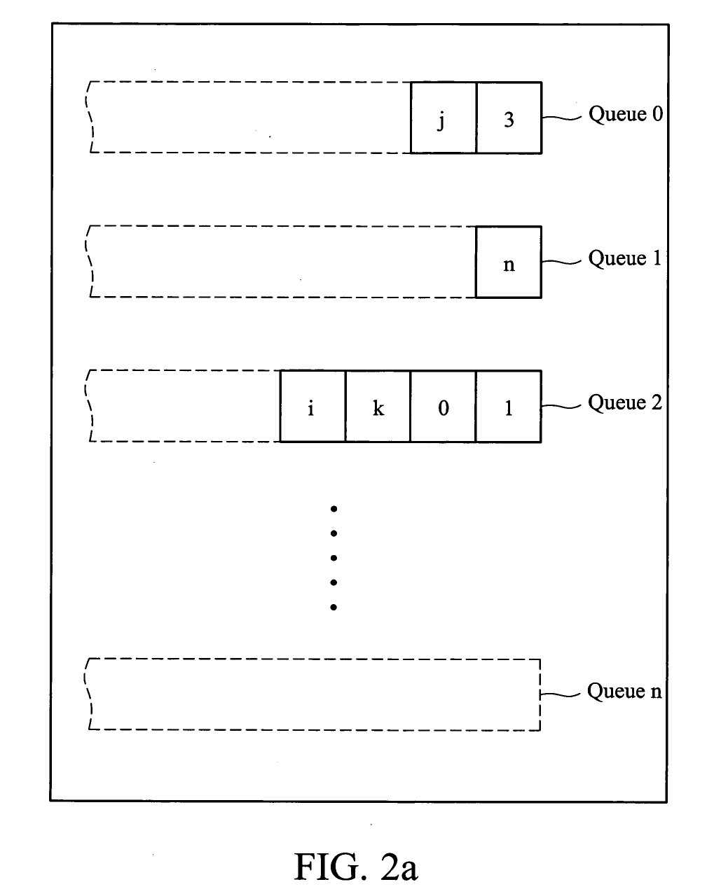

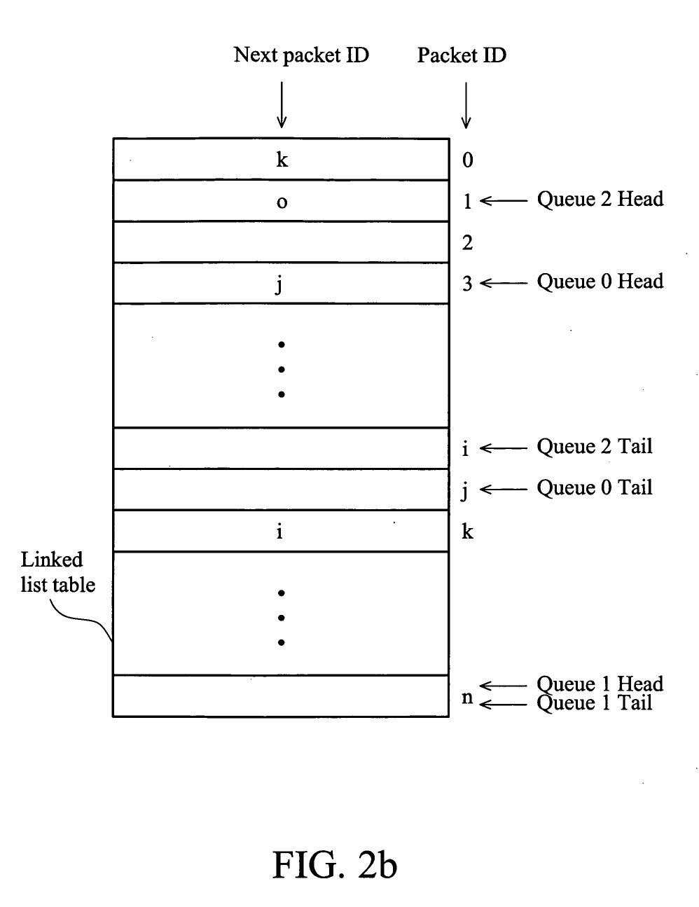

FIG. 2(a) shows an example of the queues of a switch for storing packets. Suppose there are n queues, from queue 0 to queue n, in the switch. There are 2 packets of packet 3 and j in queue 0, and the head and tail pointer of queue 0 point to packet 3 and j respectively. There is only one packet of packet n in queue 1, and the head and tail pointer of queue 1 both point to packet n. There are 4 packets of packet 1, 0, k, and i in queue 2, and the head and tail pointer of queue 2 point to packet 1 and i respectively. There is no packet in queue n, and both the head and tail pointer of queue n point to null. FIG. 2(b) shows an example of the linked list, table for storing the packets in the queues in FIG. 2(a). The linked list table stores all the packets of the switch, and the packet ID of a packet corresponds to the memory address the packet being stored. Of course, every packet stored in the linked list table has a next pointer pointing to the next packet in the same queue. “Next packet ID” in FIG. 2(b) marks the packet IDs of the packets pointed to by the next pointers of the current packets.

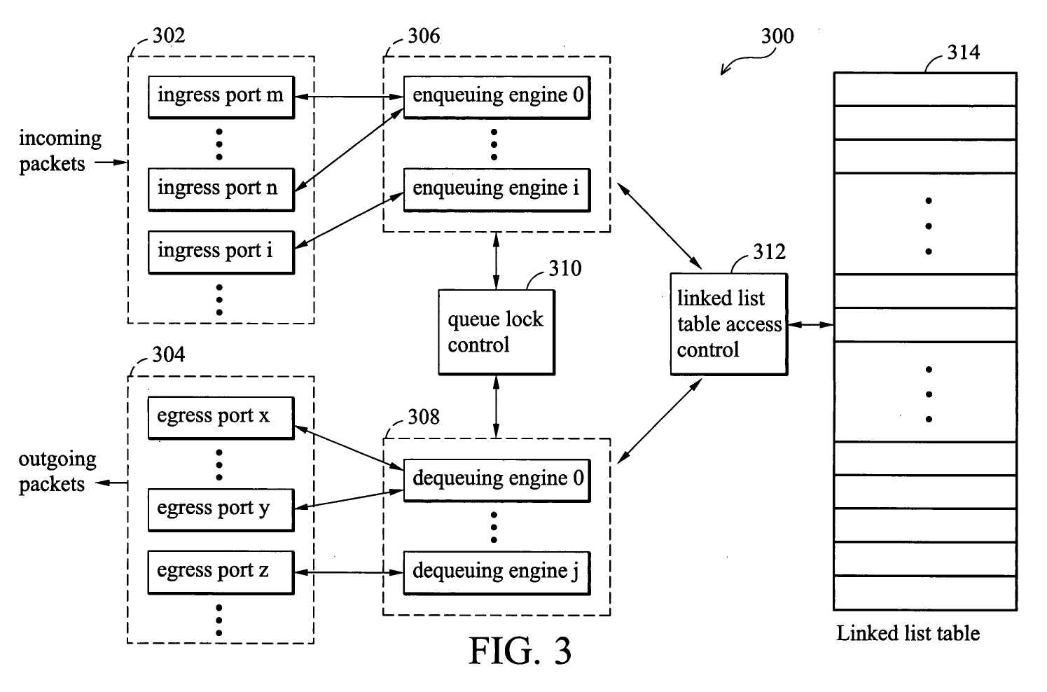

FIG. 3 shows an example of the functional blocks of en-queuing and de-queuing processes of a network switch 300. Packets come from a plurality of ingress ports 302 into the switch. The incoming packets are first stored in a plurality of queues by the en-queuing engine 306 to wait for processing by the switch. The packets are then retrieved from the plurality of queues by the de-queuing engine 308, and forwarded to the appropriate egress ports to travel to their destination after processing by the switch. As explained in FIG. 2, the packets are in practice stored in the linked list table 314.

Due to the large number of incoming packets from the plurality of ingress ports 302, implementation of only one en-queuing process is insufficient if there is only one single en-queuing engine. Thus, a plurality of en-queuing engines are provided for implementing the same en-queuing process on incoming packets. Each en-queuing engine is responsible for incoming packets from a plurality of specific ingress ports. For example, en-queuing engine 0 is responsible for en-queuing incoming packets from ingress port m to n. Accordingly, there are a plurality of de-queuing engines for implementing the same de-queuing process on the outgoing packets, and each de-queuing engine is responsible for outgoing packets to a plurality of specific ingress ports.

Queue lock control module 310 prevents potential competition between en-queuing and de-queuing processes. As there is a plurality of en-queuing engines, it is possible that two en-queuing engines want to access a specific queue at the same time to add different packets to the tail of the specific queue. Additionally, there is still the possibility that both one de-queuing engine and one en-queuing engine may want to access a specific queue at the same time. Queue lock control module 310 is responsible for verifying these instances of competition and locking one queue when it is accessed by an en-queuing or de-queuing engine. Thus, each time one en-queuing or de-queuing engine en-queues a packet to a queue or de-queues a packet from a queue, it must be granted access by the queue lock control module 310.

Linked list table access control module 312 controls access to the linked list table 314. Because the packets are actually stored in the linked list table 314, which is stored in a memory of the network switch 300, and the linked list table 314 can be read or written once per time, each en-queuing or de-queuing process must also be granted by the linked list table access control module 312.

There are still some disadvantages of the network switch 300. First, both the en-queuing and de-queuing processes must wait for approval of both the queue lock control module 310 and linked list table access control module 312, causing latency in the en-queuing and de-queuing processes. This will further reduce the bandwidth of the network switch 300. Additionally, each packet must wait for an uncertain period while been en-queued and de-queued. Thus, the latency of a packet in the network switch 300 is uncertain, and there are difficulties in evaluating the performance of the network switch 300.

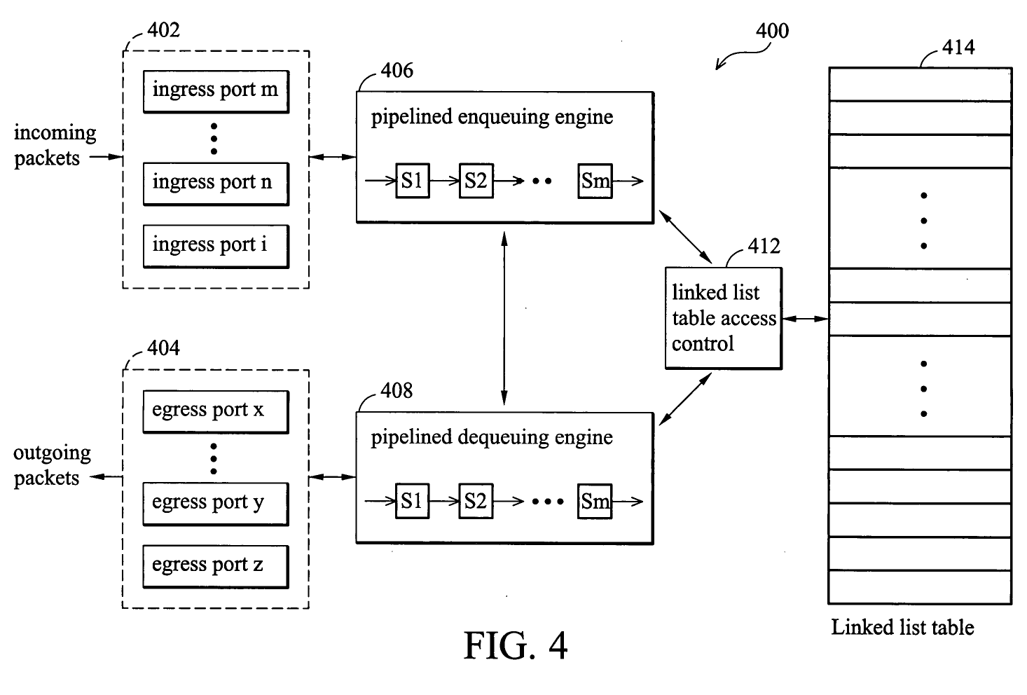

FIG. 4 shows an embodiment of the functional blocks of en-queuing and de-queuing processes of a network switch 400 according to the invention. The network switch 400 approximately resembles the network switch 300, but the structure of en-queuing engine 406 and de-queuing engine 408 are different from the en-queuing engine 306 and de-queuing engine 308. Additionally, because there is only one en-queuing engine 406 and only one de-queuing engine 408, it is impossible for two en-queuing engines to access a specific queue at the same time. Thus, there is no need for a contrast with queue lock control module 310 in network switch 400. This can facilitate the en-queuing and de-queuing processes because there is no latency caused by the queue lock control module in network switch 400.

The incoming packets from a plurality of ingress ports are delivered to the pipelined en-queuing engine 406 for implementing en-queuing processes. There is only one pipelined en-queuing engine 406 in the network switch 400, but is adequate for implementing the en-queuing process of a lot of packets. The en-queuing process in the en-queuing engine 406 is sliced into a sequence of stages. Each stage is responsible for executing a portion of the en-queuing process, and the execution time of each stage is at least one clock cycle, which is determined by the designer. Suppose the en-queuing process is sliced into m stages. Thus the pipelined en-queuing engine 406 can implement the en-queuing process of m packets at the same time, wherein each one of the m packets is processed by one of the m stage concurrently. The pipelined en-queuing engine 406 can completely en-queue one packet in one clock cycle. Additionally, the latency of the en-queuing process of one packet is shortened to m clock cycle, which is fixed because there is no uncertainly due to latency caused by queue lock control module 312 in the network switch 400.

The outgoing packets are de-queued by the pipelined de-queuing engine 408 for processing by the network switch 400 before being forwarded to a plurality of egress ports. There is only one pipelined de-queuing engine 408 in the network switch 400, but it is adequate for implementing the de-queuing process of a great number of packets. Accordingly, the de-queuing process in the de-queuing engine 408 is sliced into a sequence of stages. Each stage is responsible for executing a portion of the de-queuing process, and the execution time of each stage is at least one clock cycle, which is determined by the designer. Suppose the de-queuing process is sliced into n stages. Thus, the pipelined de-queuing engine 408 can implement the de-queuing process of n packets at the same time, wherein each of the n packets is concurrently processed by one of the n stages. The pipelined de-queuing engine 408 can completely de-queue one packet in one clock cycle. Additionally, the latency of the de-queuing process of one packet is shortened to n clock cycles, which is fixed because there is no uncertainty due too latency caused by queue lock control module 312 in the network switch 400.

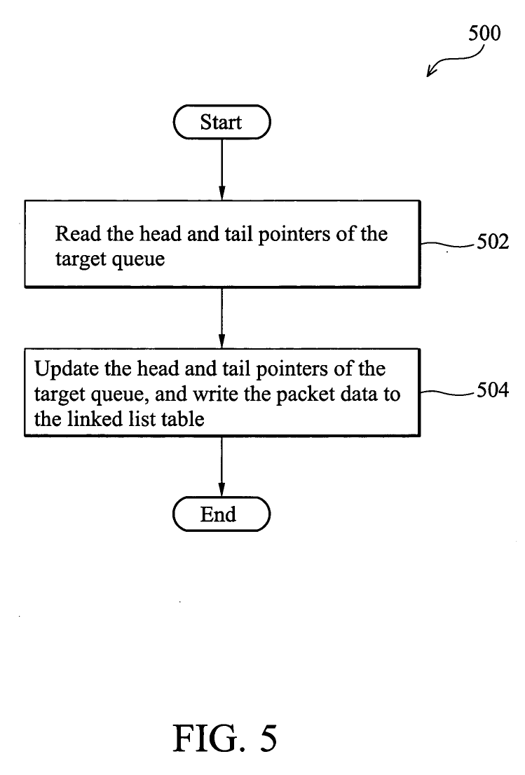

FIG. 5 shows an embodiment of en-queuing process 500 implemented by pipelined en-queuing engine 406. The en-queuing process 500 is divided into two stages: step 502 and step 504, which correspond to stages S1 through stage Sm in FIG. 4. There are registers storing relevant information of the stage at each en-queuing stage. For example, the registers could be a stage active flag for marking whether there is still a packet being processed in the stage, an id of the target queue, or an id of the en-queuing packet. Each time a packet is delivered to the next stage, the stage active flag of the next stage must be checked to ensure that the next stage is not busy.

When an incoming packet from ingress port 402 is to be en-queued to a target queue, it must be processed by the pipelined en-queuing engine 406 in steps 502 and 504. Step 502 and 504 respectively correspond to stage 1 and stage 2 in FIG. 4. The head and tail pointers of the target queue are first read in step 502. Thus, the packet can be appended to the tail of the target queue. The purpose for reading the head pointer is to determine whether the head pointer points to null. If so, the target queue is an empty queue, and the head pointer must be altered to point to the new packet in step 504. Otherwise the head pointer remains unchanged. The new packet data is then written to the linked list table 414 in step 504. The next pointer of the packet pointed by the tail pointer is changed to point to the packet id of the new packet, and the tail pointer is changed to then point to the packet id of the new packet in step 504. Thus, the pipelined en-queuing engine 406 can process 2 packets at the same time with each packet in one of the stages and finish the en-queuing process of one packet for every one clock cycle. The latency of the en-queuing process is 2 clock cycles.

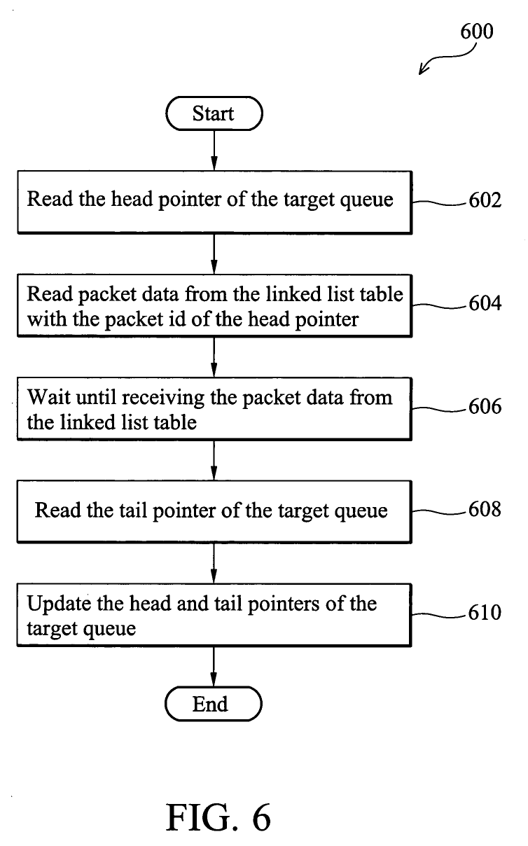

FIG. 6 shows an embodiment of de-queuing process 600 implemented by pipelined de-queuing engine 408. The de-queuing process 600 is divided into five stages: step 602 to 610, which correspond to the stage S1 through stage Sn in FIG. 4. There are also registers storing relevant information of the stage at each de-queuing stage. For example, the registers could be a stage active flag for marking whether there is still a packet processed in the stage, an id of the target queue, or an id of the de-queuing packet. Each time a packet is delivered to the next stage, the stage active flag of the next stage must be checked to ensure that the next stage is not busy.

When an outgoing packet is to be de-queued from a target queue to be forwarded to egress port 404, it must be processed by the pipelined de-queuing engine 408 with step 602 to 610. Step 602, 604, 606, 608, and 610 respectively correspond to stage 1, 2, 3, 4, and 5 in FIG. 4. The head pointer of the target queue is first read in step 602. Thus, the packet at the head of the target queue can be retrieved. The packet data is then read from the linked list table 414 in step 604. Because the latency of the reading operation of the linked list table 414 is more than one clock cycle, the pipelined de-queuing engine 408 must wait for one more clock cycle in step 606 until the packet data is received. The tail pointer of the target queue is then read in step 608, and the purpose for reading the tail pointer is to check whether the tail pointer also points to the same packet as the head pointer. If so, the target queue is an empty queue after the packet is retrieved, and both the head and tail pointers must be altered to point to null in step 610. Otherwise the tail pointer remains unchanged. The head pointer is then changed to point to the next packet of the head packet in step 610. On the other side, each stage in the de-queuing process 600 must verify whether the target queue is en-queued by a stage in the en-queuing process 500 in advance to prevent potential competition. The solution is to compare the ids of the target queue of the en-queuing and de-queuing stages, and the result of the comparison is taken as the basis for deciding whether the updating operation in the step 610 should be suppressed. Thus, the pipelined de-queuing engine 408 can process 5 packets at the same time with each packet in one of the stages and finish the de-queuing process of one packet within every one clock cycle. The latency of the de-queuing process is 5 clock cycles.

In this disclosure, we provide a method for implementing packet en-queuing and de-queuing processes in a network switch. Because the method uses the pipeline-style processing structure in both en-queuing and de-queuing processes in the switch, the number of packets processed at the same time can be increased and the latency time in both the en-queuing and de-queuing processes can be reduced. Thus, the bandwidth of the network switch can be increased, and the latency of a packet in both the en-queuing and de-queuing process can be a fixed period. On the other hand, only one en-queuing and de-queuing engine is required for implementing the en-queuing and de-queuing process, and the design of the network switch can be simplified. Moreover, a queue lock control which delays the en-queuing and de-queuing processes is eliminated. Thus, the performance of the network switch can be greatly improved.

Finally, while the invention has been described by way of example and in terms of the above, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for implementing packet en-queuing and de-queuing processes in a network switch, the method comprising the steps of:
dividing an en-queuing process and a de-queuing process into a plurality of en-queuing and de-queuing stages respectively;
processing the en-queuing process of a plurality of en-queued packets with each one of the plurality of en-queued packets processed in one of the plurality of en-queuing stages simultaneously wherein each of the plurality of en-queued packets passes through all of the plurality of en-queuing stages sequentially to complete the en-queuing process; and
processing the de-queuing process of a plurality of de-queued packets with each one of the plurality of de-queued packets processed in one of the plurality of de-queuing stages simultaneously, wherein each of the plurality of de-queued packets passes through all of the plurality of de-queuing stages sequentially to complete the de-queuing process.

2. The method according to claim 1, the plurality of en-queuing stages further comprising:
en-queuing stage 1: reading a tail pointer of a target queue to which an en-queued packet will be appended; and
en-queuing stage 2: pointing the tail pointer of the target queue towards the en-queued packet and writing data of the en-queued packet into a memory.

3. The method according to claim 2, wherein the en-queuing stage 1 also includes reading a head pointer of the target queue to check whether the head pointer points to null, and the en-queuing stage 2 also includes pointing the head pointer towards the en-queued packet if the head pointer points to null in the en-queuing stage 1.

4. The method according to claim 1, the plurality of de-queuing stages further comprising:
de-queuing stage 1: reading a head pointer of a target queue from which a de-queued packet will be retrieved;
de-queuing stage 2: reading data of the de-queued packet from a memory according to the head pointer;
de-queuing stage 3: waiting until the data of the de-queued packet is received from the memory;
de-queuing stage 4: reading a tail pointer of the target queue to check whether the tail pointer points to the same packet as the head pointer; and
de-queuing stage 5: pointing both the head pointer and the tail pointer towards null if the tail pointer points to the same packet as the head pointer in the de-queuing stage 4, otherwise pointing the head pointer towards a next packet.

5. The method according to claim 1, wherein each one of the plurality of de-queuing stages will check whether a target queue of the de-queuing stage is en-queued by one of the plurality of en-queuing stages at the same time in advance, and the de-queuing stage will be halted if the target queue of the de-queuing stage is en-queued by one of the plurality of en-queuing stages at the same time.

6. The method according to claim 1, wherein each one of the plurality of de-queuing stages will check whether a target queue of the de-queuing stage is en-queued by one of the plurality of en-queuing stages at the same time in advance to prevent a competition for queue position, and the one of the plurality of the en-queuing stages will be halted if the target queue of the de-queuing stage is en-queued by the one of the plurality of en-queuing stages at the same time.

7. The method according to claim 1, wherein an execution period of each one of the plurality of en-queuing stages is substantially equal, and an execution period of each one of the plurality of de-queuing stages is substantially equal.

8. The method according to claim 1, wherein an execution period of every one of the plurality of en-queuing stages is at least one clock cycle of the network switch, and an execution period of every one of the plurality of de-queuing stages is also at least one clock cycle of the network switch.

9. The method according to claim 1, wherein a stage active flag is associated to every one of the plurality of en-queuing and de-queuing stages for marking whether a packet is still in process in the en-queuing or de-queuing stage, and whenever a packet is delivered from a current stage to a next stage of the plurality of en-queuing and de-queuing stages, the stage active flag of the next stage is checked in advance to assure that there is no packet in process in the next stage.

10. A network switch, the network switch comprising:
a pipelined en-queuing engine, for processing an en-queuing process of a plurality of en-queued packets, wherein the en-queuing process is divided into a plurality of en-queuing stages, and each one of the plurality of en-queued packets is processed in one of the plurality of en-queuing stages simultaneously, and every one of the plurality of en-queued packets passes through all of the plurality of en-queuing stages sequentially to complete the en-queuing process; and
a pipelined de-queuing engine, for processing a de-queuing process of a plurality of de-queued packets, wherein the de-queuing process is divided into a plurality of de-queuing stages, and each of the plurality of de-queued packets is processed in one of the plurality of de-queuing stages simultaneously, and each of the plurality of de-queued packets passes through all of the plurality of de-queuing stages sequentially to complete the de-queuing process.

11. The network switch according to claim 10, further comprises a linked list table, stored in a memory of the network switch and coupled to both the pipelined en-queuing engine and the pipelined de-queuing engine, for storing data of the plurality of en-queued packets, and data of the plurality of de-queued packets is retrieved from the linked list table.

12. The network switch according to claim 11, wherein the plurality of en-queuing stages includes a first en-queuing stage and a second en-queuing stage, and the pipelined en-queuing engine includes means for reading a tail pointer of a target queue to which an en-queued packet will be appended in the first en-queuing stage, means for pointing the tail pointer of the target queue towards the en-queued packet in the second en-queuing stage, and means for writing data of the en-queued packet into the linked list table in the second en-queuing stage.

13. The network switch according to claim 12, wherein the pipelined en-queuing engine also includes means for reading a head pointer of the target queue to check whether the head pointer points to null in the first en-queuing stage, and the pipelined en-queuing engine also includes means for pointing the head pointer towards the en-queued packet in the second en-queuing stage if the head pointer points to null in the first en-queuing stage.

14. The network switch according to claim 11, wherein the plurality of de-queuing stages includes a first de-queuing stage, a second de-queuing stage, a third de-queuing stage, a fourth de-queuing stage, and a fifth de-queuing stage, and the pipelined de-queuing engine includes means for reading a head pointer of a target queue from which a de-queued packet will be retrieved in the first de-queuing stage, means for reading data of the de-queued packet from the linked list table according to the head pointer in the second de-queuing stage, means for waiting until the data of the de-queued packet is received from the linked list table in the third de-queuing stage, means for reading a tail pointer of the target queue to check whether the tail pointer points to the same packet as the head pointer in the fourth de-queuing stage, and means for pointing both the head pointer and the tail pointer towards null in the fifth de-queuing stage if the tail pointer points to the same packet as the head pointer in the fourth de-queuing stage.

15. The network switch according to claim 10, wherein the pipelined de-queuing engine includes means for checking whether a target queue of each one of the plurality of de-queuing stages is en-queued by one of the plurality of en-queuing stages of the pipelined en-queuing engine at the same time in advance, and the pipelined de-queuing engine includes means for halting one of the plurality of de-queuing stages if the target queue of the one of the plurality of de-queuing stages is en-queued by one of the plurality of en-queuing stages at the same time.

16. The network switch according to claim 10, wherein the pipelined en-queuing engine includes means for checking whether a target queue of each one of the plurality of en-queuing stages is de-queued by one of the plurality of de-queuing stages of the pipelined de-queuing engine at the same time in advance, and the pipelined en-queuing engine includes means for halting one of the plurality of en-queuing stages if the target queue of the one of the plurality of en-queuing stages is de-queued by one of the plurality of de-queuing stages at the same time.

17. The network switch according to claim 10, wherein an execution period of each of the plurality of en-queuing stages is substantially equal, and an execution period of each of the plurality of de-queuing stages is substantially equal.

18. The network switch according to claim 10, wherein an execution period of each of the plurality of en-queuing stages is at least one clock cycle of the network switch, and an execution period of each of the plurality of de-queuing stages is also at least one clock cycle of the network switch.

19. The network switch according to claim 10, wherein there is a stage active flag associated to every one of the plurality of en-queuing and de-queuing stages for marking whether there is still a packet in process in the en-queuing or de-queuing stage, and whenever a packet is delivered from a current stage to a next stage of the plurality of en-queuing and de-queuing stages, the pipelined en-queuing engine and the pipelined de-queuing engine include means for checking the stage active flag of the next stage in advance to ensure that there is no packet in process in the next stage.
